(19) United States
(12) Patent Application Publication
(10) Pub. No.: US 2019/0170109 A1
(43) Pub. Date: Jun. 6, 2019

(54) PUMPED STORAGE HYDROPOWER SYSTEM

(71) Applicant: Littoral Power Systems Inc., New Bedford, MA (US)

(72) Inventors: David Duquette, Monmouth Junction, NJ (US); Katherine Leighton, Media, PA (US)

(21) Appl. No.: 16/265,984

(22) Filed: Feb. 1, 2019

Related U.S. Application Data
(63) Continuation of application No. 15/726,982, filed on Oct. 6, 2017, now abandoned.
(60) Provisional application No. 62/405,545, filed on Oct. 7, 2016.

(51) Int. Cl. F03B 13/06; G06Q 50/06; F03B 13/08; G05F 1/66; F03B 17/06; G05B 15/02; F03B 3/10; F04B 17/00

(52) U.S. Cl. CPC F03B 13/06; G06Q 50/06; F03B 13/08; G05F 1/66; F03B 17/06; G05B 15/02; F05B 2240/40; F04B 17/006; Y02E 60/17; Y02E 10/28; Y02E 10/22; Y02E 10/223; F03B 3/10

(57) ABSTRACT

A pumped storage hydropower apparatus includes a housing and at least one pump disposed within the housing. The at least one pump is configured to operate in a first mode of operation or a second mode of operation based on an operation condition including at least one of a time or a price of electrical power from a remote electrical power source. In the first mode of operation, the at least one pump receives a first flow of water from a first water storage unit, transports the first flow to a second water storage unit, and generates electrical power for transmission to the remote electrical power source. In the second mode of operation, the at least one pump receives a second flow of water from the second water storage unit, and transports the second flow to the first water storage unit using electrical power from the remote electrical power source.

### CROSS-REFERENCE TO RELATED APPLICATIONS

This patent application is a continuation of, and claims the benefit of and priority to U.S. patent application Ser. No. 15/726,982, titled “PUMPED STORAGE HYDROPOWER SYSTEM,” and filed Oct. 6, 2017, which claims the benefit of and priority to U.S. Provisional Patent Application No. 62/405,545, titled “INNOVATIVE SMALL PUMPED STORAGE SYSTEM,” and filed on Oct. 7, 2016, all of which are hereby incorporated by reference into the present application in its entirety.

### TECHNICAL FIELD

The present disclosure relates generally to the field of power generation systems, and more particularly to a pumped storage hydropower system.

### BACKGROUND

The growing use of intermittent renewable energy (wind and solar) in distributed electricity is driving a demand for energy storage. While pumped storage hydropower (PSH) plants have many advantages including long life cycle and among the lowest costs per unit energy when compared to other energy storage mechanisms such as batteries and flywheels, they are typically large installations hindered by high capital costs, lengthy deployment times and uncertain revenue streams and regulatory timeframes.

Smaller energy storage is currently served with a variety of battery storage options which are more expensive per unit of energy than PSH, have limited life cycle, and many rely on specialized materials only available from foreign supply. Small, or micro PSH has the advantage of lower capital costs and relatively rapid deployment as compared to larger PSH facilities, and addresses the limitations with battery storage. However, existing PSH systems are not yet economical and have not yet overcome the engineering challenges required to achieve economic operation. For example, Oak Ridge National Laboratory identified daunting challenges in their study of the feasibility of <1 MW modular PSH (mPSH) using a model of placing water tanks at different elevations in buildings and using them to provide a fraction of the building's energy load. They determined that a substantial volume of water is required to provide such a small fraction of the building's energy load that it was unlikely to be economical, and presented significant engineering challenges.

### SUMMARY

An embodiment of the present disclosure relates to a pumped storage hydropower system. The pumped storage hydropower system includes a first water storage unit storing a first volume of water at a first elevation, a second water storage unit storing a second volume of water at a second elevation less than the first elevation, a housing, a power generation system, and a control circuit. The power generation system includes at least one pump disposed within the housing and an electrical generator. The at least one pump is fluidly coupled to the first water storage unit and the second water storage unit to transport water between the first water storage unit and the second water storage unit. The electrical generator operatively is coupled to the at least one pump. The electrical generator is configured to receive electrical power from and transmit electrical power to a remote electrical power source. The control circuit is configured to control operation of the power generation system in a first mode of operation or a second mode of operation based on an operation condition. The operation condition includes at least one of a time or a price of the electrical power received from the remote electrical power source. In the first mode of operation, the control circuit causes the at least one pump to receive a first flow of the first volume of water from the first water storage unit, transport the first flow to the second water storage unit, and drive the electrical generator to generate electrical power for transmission to the remote electrical power source using the first flow. In the second mode of operation, the control circuit causes the electrical generator to drive the at least one pump, using electrical power received from the remote electrical power source, to receive a second flow of the second volume of water from the second water storage unit and transport the second flow to the first water storage unit.

Another embodiment of the present disclosure relates to a pumped storage hydropower apparatus. The pumped storage hydropower apparatus includes a housing and at least one pump disposed within the housing. The at the at least one pump is fluidly coupled to a first water storage unit storing a first volume of water at a first elevation and a second water storage unit storing a second volume of water at a second elevation less than the first elevation. The at least one pump is configured to operate in a first mode of operation or a second mode of operation based on an operation condition including at least one of a time of day or a price of electrical power received from a remote electrical power source. In the first mode of operation, the at least one pump receives a first flow of the first volume of water from the first water storage unit, transports the first flow to the second water storage unit, and generates electrical power for transmission to the remote electrical power source using the first flow. In the second mode of operation, the at least one pump receives a second flow of the second volume of water from the second water storage unit, and transports the second flow to the first water storage unit using electrical power received from the remote electrical power source.

Another aspect of the present disclosure relates to a pumped storage hydropower system. The pumped storage hydropower system includes a plurality of second water storage units storing corresponding second volumes of water at a plurality of second elevations less than a first elevation at which a first water storage unit stores a first volume of water and a housing and at least one pump disposed within the housing. The at least one pump is fluidly coupled to the first water storage unit and the plurality of second water storage unit to transport water between the first water storage unit and the plurality of second water storage unit. The at least one pump is configured to operate in a first mode of operation or a second mode of operation based on an operation condition including at least one of a time or a price of electrical power received from a remote electrical power source. In the first mode of operation, the at least one pump receives a first flow of the first volume of water from the first water storage unit, transports the first flow to at least one of the plurality of second water storage unit, and generates electrical power for transmission to the remote electrical power source using the first flow. In the second mode of operation, the at least one pump receives a second flow of at least one of the second volumes of water from at least one of the plurality of second water storage unit, and transports the second flow to the first water storage unit using electrical power received from the remote electrical power source.

It should be appreciated that all combinations of the foregoing concepts and additional concepts discussed in greater detail below (provided such concepts are not mutually inconsistent) are contemplated as being part of the inventive subject matter disclosed herein. It should be appreciated that terminology explicitly employed herein that may also appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a block diagram of a pumped storage hydropower system according to an embodiment of the present disclosure.

FIG. 2A is a schematic diagram of a pumped storage hydropower system using an existing water reservoir according to an embodiment of the present disclosure.

FIG. 2B is a schematic diagram of a pumped storage hydropower system using a modular water reservoir according to an embodiment of the present disclosure.

FIG. 3A is a schematic diagram of a modular housing and power generation system of a pumped storage hydropower system with a reversible pump/turbine according to an embodiment of the present disclosure.

FIG. 3B is a schematic diagram of a modular housing and power generation system of a pumped storage hydropower system with separate pump and turbine components according to an embodiment of the present disclosure.

FIG. 4 is a method of operating a pumped storage hydropower system according to an embodiment of the present disclosure.

The features and advantages the inventive concepts disclosed herein will become more apparent from the detailed description set forth below when taken in conjunction with the drawings.

### DETAILED DESCRIPTION

Following below are more detailed descriptions of various concepts related to, and embodiments of, inventive systems, methods and apparatus for pumped storage hydropower systems. It should be appreciated that various concepts introduced above and discussed in greater detail below may be implemented in any of numerous ways, as the disclosed concepts are not limited to any particular manner of implementation. Examples of specific implements and applications are provided primarily for illustrative purposes.

Referring to the figures generally, the present solution overcomes challenges associated with existing PSH systems by using standardized power modules with low capital cost and which rely on previously unused efficiencies in operation of the PSH systems. In some embodiments, PSH systems in accordance with the present disclosure take advantage of existing infrastructure and new regulations for not only streamlined licensing for closed-loop pumped hydropower but also exemptions for conduit projects. Standardized power modules can be easily transported anywhere in the US with the possibility to populate tens or hundreds of sites to form a distributed network of coordinated storage/power nodes. In some embodiments, each module has about 600 kW capacity that can be used to supply bursts of high energy or a constant draw for up to 4 hours. Applying advanced electrical machine technology to robust pumping and generating equipment can create highly efficient facilities that can be cycled on and off between pumping and generating many times an hour—for years. Such flexibility can maximize revenues on the arbitrage market and in other energy storage value streams.

In some embodiments, the present solution improves upon existing PSH systems through engineering design, analysis and modeling of a modular pump/power house for mPSH system enabling low capital costs and short deployment timeframes. Various such embodiments can achieve >70% round trip efficiency, pose no adverse effect on the existing infrastructure, and have favorable economic and market conditions resulting in an acceptable payback period. The growing use of intermittent renewable energy (wind and solar) in distributed electricity is driving a demand for energy storage. While pumped storage hydropower (PSH) plants have many advantages including long life cycle and among the lowest costs per unit energy when compared to other energy storage mechanisms such as batteries and flywheels, they are typically large installations hindered by high capital costs, lengthy deployment times and uncertain revenue streams and regulatory timeframes. On the other hand, PSH systems in accordance with the present disclosure can improve upon existing PSH systems by reducing capital costs and deployment timeframes.

The present solution advances PSH technology by focusing on a modular shipping container pump/power house PSH system enabling low capital costs and short deployment timeframes. In various embodiments, this can be achieved by developing equipment specifications for advanced technology, adjustable speed, high efficiency pump/turbines that fit inside the modular shipping container; integrating the PSH system with existing water storage to reduce capital costs for the PSH system; and configuring the PSH system based on technical, economic and market feasibility. In some embodiments, the PSH system can provide a round trip efficiency (RTE) of 70% or greater is possible; pose no adverse effect on a water supply system (and may improve the water supply system by mixing water to prevent issues associated with stagnant, unmixed water); and limit capital costs in view of electricity markets to make payback possible in less than thirty years.

In addition, PSH systems in accordance with the present disclosure can improve upon battery-based small energy storage systems. Smaller energy storage is currently served with a variety of battery storage options including sodium-metal halides, vanadium redux, Fe/Cr, Zn/Bromide, lead acid, and lithium-ion, which are more expensive per unit of energy than PSH, have limited life cycle, and many rely on specialized materials only available from foreign supply. Small, or micro PSH has the advantage of lower capital costs and relatively rapid deployment as compared to larger PSH facilities, and addresses the limitations with battery storage. However, as noted above, Oak Ridge National Laboratory identified daunting challenges in their study of the feasibility of <1 MW modular PSH (mPSH) using a model of placing water tanks at different elevations in buildings and using them to provide a fraction of the building's energy load. They determined that a substantial volume of water is required to provide such a small fraction of the building's energy load that it was unlikely to be economical, and presented significant engineering challenges.

The present solution provides an approach that addresses these shortcomings, reduces capital costs and leads to shortened timeframes for PSH deployment. In some embodiments, systems in accordance with the present disclosure uses municipal or private elevated water storage, i.e. water towers or standpipes, as an upper reservoir. As such, it will be appreciated that the infrastructure is already in place for the upper reservoir. Additionally, in many cases the necessary lower reservoir is already in place as well: many water towers are equipped with water tanks, typically underground, to handle excess water storage. Water towers can store millions of gallons of water elevated 100 feet or more in the air. In some embodiments, the present solution can rely on the existing upper reservoirs to address engineering challenges and capital costs associated with storing a large volume of water at a relatively high elevation. Similarly, in some embodiments, the upper reservoir systems may be able to protect the water from freezing and stagnation, such as by periodically pumping/draining to keep the water in motion. In some embodiments, pumps already in place may eliminate the need for a separate pump. In some embodiments, building an mPSH capability based on an existing water tower can be treated as a conduit project for purposes of Federal Energy Regulatory Commission (FERC) licensing requirements, and as such is eligible for exemption from permitting or at least a greatly accelerated permitting process.

In some embodiments, a PSH system in accordance with the present disclosure can overcome existing challenges to deployment for pumped storage hydropower by operating as a conduit hydropower facility. The Hydropower Regulatory Efficiency Act of 2013 (Public Law 113-23), signed into law in August 2013, provides a streamlined two year licensing process for closed-loop pumped storage projects. But linking the proposed mPSH system with an existing water works, as the proposed modular technology does, may meet the standards for a conduit hydropower facility exemption under this same law (e.g.: (i) under 5 MW in nameplate capacity, (ii) uses a non-federally owned conduit, and (iii) held no license or exemption before the Act was enacted). It will be appreciated that Conduit exemptions do not require a FERC license, and the required permitting process can be less than a year and possibly only a few months.

As such, the feasibility of a PSH system as disclosed herein, implements advanced hydropower and pump equipment, is modularized, and is integrated with existing water works in power ranges less than 5 MW, will advance the state of PSH technology in a power class with the most favorable regulatory timeframes. Such PSH system can improve PSH technology by facilitating implementation of containerized power/pump house for mPSH, and also for expanded capabilities in small hydropower, conduit hydropower, and expansion into larger PSH facilities in collaboration with water works departments. For instance, adding storage to a water supply system might not require a separate pump/power house—one might be able to achieve marketable storage by adding water to existing tanks and modifying the supply pumps at the treatment plant. Systems operated in accordance with the present disclosure can provide data not only to assess the feasibility of the proposed modular power/pump house mPSH system, but also addresses in part this wider water supply opportunity. The pump/turbine that is specified as part of the system can be used in the shipping container mPSH, and may also offer water supply systems a low energy use pump with generation capabilities, and may be appropriate for other small hydropower applications including conduits.

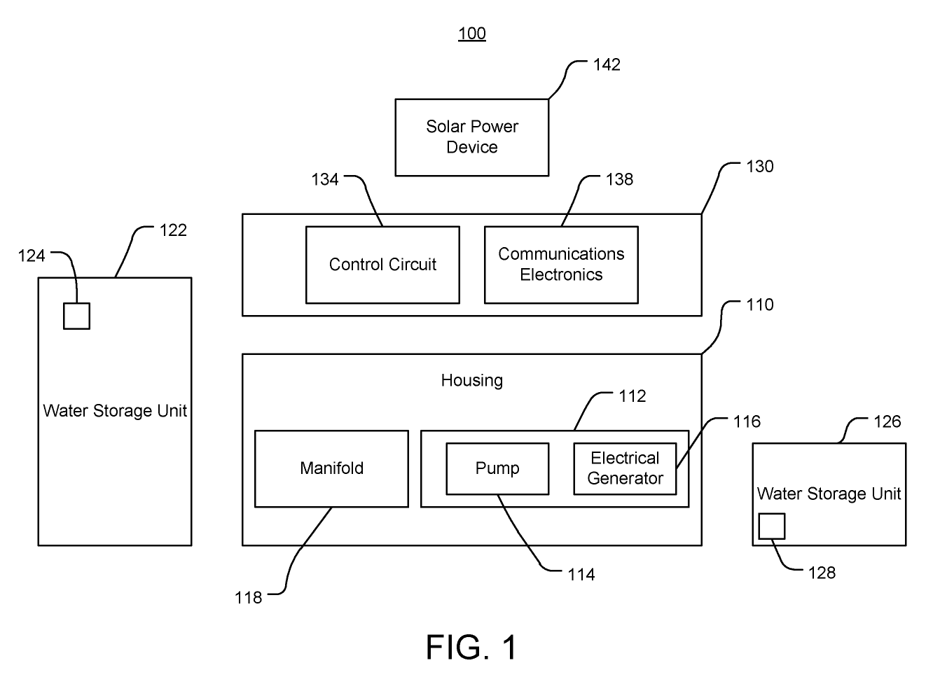

Referring now to FIG. 1, a pumped storage hydropower (PSH) system 100 is shown according to an embodiment of the present disclosure. Briefly, the PSH system 100 includes a housing 110, a power generation system 112 including at least one pump 114 and at least one electrical generator 116, a first water storage unit 122, and at least one second water storage unit 126.

The housing 110 can be a pre-fabricated, modular pump/power house. The housing 110 can made out of a shipping container. In some embodiments, the housing 110 is made from a shipping containers which is 8 feet wide and 8.5 feet high (e.g., a standard or ISO-certified shipping container). In various embodiments, the housing 110 may be made from a shipping container having standard lengths of 40, 20 or 10 feet. In some embodiments, the two longer containers are also available in 9.5 feet height. The housing 110 may be made from a shipping container which sells for less than $2,000 each, contributing to the relatively low capital cost of the present solution. An ISO-certified 40-foot container can hold over 60,000 lbs. of payload and is designed to be able to survive ship transport with eight other fully loaded containers stacked on top of it. The housing 110 can be quickly and easily clipped onto the bed of a semi-truck trailer or a rail car, and be inexpensively shipped to any water tower site in the country.

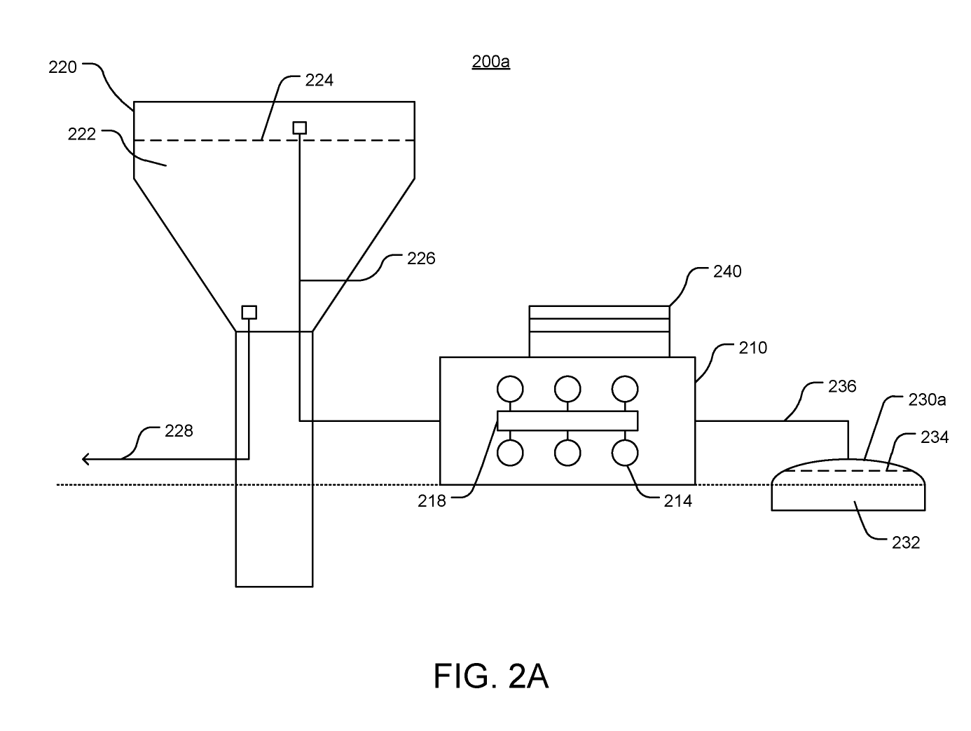

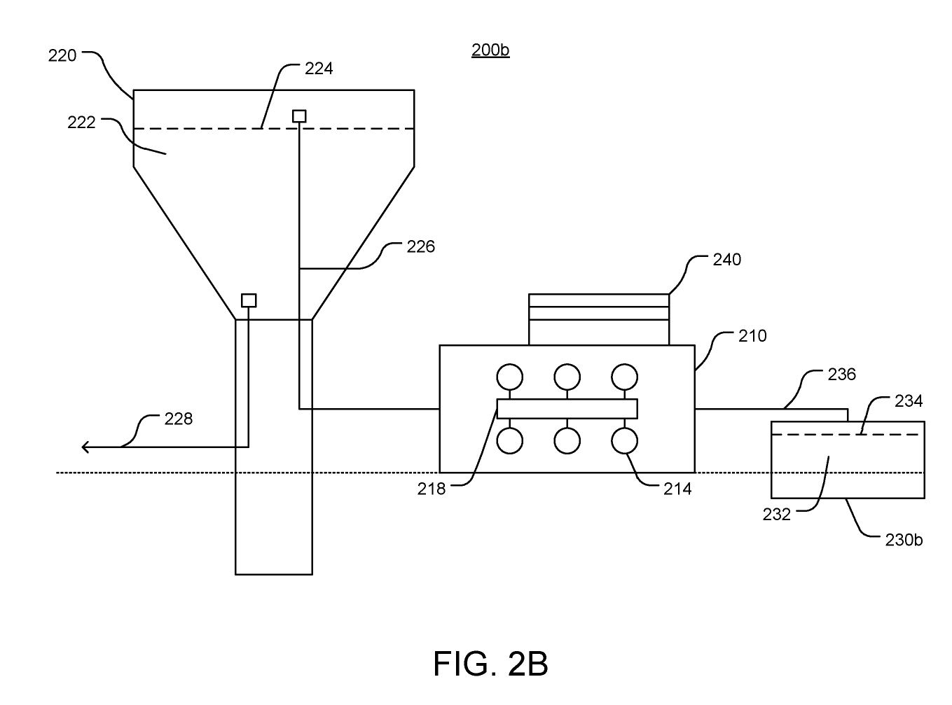

As will be described in further detail with reference to FIG. 2B, in some embodiments, such as when being implemented at sites where a lower reservoir is not available or existing reservoirs are insufficient for storage needs, the water storage unit 126 can be implemented as a series of paired shipping containers (similar to the housing 110) fitted with liner, which can be used as low cost tanks that can be rapidly set up above or below ground. In some embodiments, when the water storage unit 126 is configured as a 40-foot high cube, 9.5 feet tall, container, the water storage unit 126 can hold over 20,000 gallons of water (e.g. each pair of water storage units 126 holds upwards of 40,000 gallons).

In some embodiments, the power generation system 112 is disposed within the housing 110. For example, the at least one pump 114 and the at least one electrical generator 116 can be mounted to interior surfaces of the housing 110. As such, the PSH system 100 can be modular, as each housing 110, containing the power generation system 112, can be deployed and coupled to water storage units and remote electrical power sources without requiring additional installation of power generation components.

The first water storage unit 122 (e.g., upper reservoir) stores a first volume of water at a first elevation. The first water storage unit 122 may be an existing water tower tank (e.g., at a height of 100 feet or greater). The water storage unit 122 may be connected to a remote water system, such as a municipal water system, to deliver water to the remote water system. The water storage unit 112 is fluidly coupled to the housing 110.

In some embodiments (e.g., as will be described with further reference to FIG. 2A), the at least one second water storage unit 126 is an existing water reservoir. The at least one water storage unit 126 stores a second volume of water at a second elevation. The second elevation may be at or near ground level. For example, the at least one second water storage unit 126 may be located on a ground surface, or may be at least partially underground. The second water storage unit 126 is also fluidly coupled to the housing 110. In some embodiments (e.g., as will be described with further reference to FIG. 2B, the second water storage unit 126 is implemented using a shipping container.

The American Water Works Association (AWWA) prepared a report for the Environmental Protection Agency (EPA) pointing out that, because of past hydraulic design approaches, many of today's water towers (e.g., water towers which may be implemented as the first water storage unit 122) have excess capacity. Some are not filled to capacity because underutilization can harm water quality. Finished (i.e. potable) water storage often includes both ground storage and elevated storage, meaning that in the case of pumped storage hydropower both the upper reservoir (e.g., first water storage unit 122) and lower reservoir (e.g., second water storage unit 126) may already exist. Ground storage of the second water storage unit 126 can be below ground, partially below, or on level grade. The most common types of elevated storage (e.g., first water storage unit 122) are steel or concrete tanks or standpipes. Storage tanks of the first water storage unit 122 can be capable of holding 1,000,000 to 3,000,000 gallons are common and some can hold up to 10,000,000 gallons. The first water storage unit 122 may be a composite hydro pillar tank. The second water storage unit 126 may be a concrete ground storage unit.

The first water storage unit 122 may or may not have excess capacity. As some examples of existing systems similar to which the PSH system 100 could be implemented, Swarthmore College, a college in Southeastern PA runs much like a small city and has its own water tower; a small one with only 250,000 gallons that has no extra room or capacity. The City of Philadelphia, on the other hand, has large excess capacity of water with a 214 million gallon reservoir and capability to regularly pump 40 to 60 million gallons of water each night. Cleveland Tenn., a city with nearly 40,000 electricity customers and over 30,000 water customers, is currently partnering with ORNL to develop a water delivery model to assess water delivery and energy storage synergies, including the possibility of using excess head-room in their water towers. The PSH system 100 may utilize such excess capacity for transporting water between the first water storage unit 122 and the second water storage unit 126 (or may transport some water to second water storage unit(s) 126 to create excess capacity where the first water storage unit 122 does not have excess capacity).

Because of the difference in elevation between the first volume of water of the first water storage unit 122 and the second volume of water of the second water storage unit 126, and thus an associated difference in potential energy, kinetic energy will result from water flow from the first water storage unit 122 to the second water storage unit 126; similarly, kinetic energy is required to transport water from the second water storage unit 126 to the first water storage unit 122. The PSH system 100 can take advantage of these kinetic energies by using the kinetic energy from water flow from the first water storage unit 122 to the second water storage unit 126 to generate electrical power under conditions when the price of electricity is relatively high, and using electrical power under conditions when the price of electricity is relatively low to generate the kinetic energy needed to transport water from the second water storage unit 126 to the first water storage unit 122. It will be appreciated that the economics of PSH operation depend on the efficiency of operation of the PSH system 100; the technical improvements over existing PSH systems described in the present disclosure can provide efficiency improvements to overcome these economic challenges.

The PSH system 100 can convert an existing first water storage unit 122 (e.g., water tower) into a pumped storage hydropower facility by providing the modular housing 110, made from a shipping container, and the associated power generation system 112.

Water towers which can be implemented as the first water storage unit 122 may vary in height and capacity. Each water supply system is expected to have a different amount of water available for energy generation. To standardize the PSH system 100 for low costs and rapid deployment, and still address the site-to-site variability, each PSH system 100 (e.g., housing 110 and power generation system 112) can varying numbers of pumps 114, or may selectively operate pumps 114. For example, for a site with a low volume of water, the PSH 114 may only contain a single pump 114. Additional pumps 114 can be added for higher volumes.

Multiple units provide flexibility to operate one or more at a time. All units would be operated for rapid draining and maximum energy generation, and fewer units for slower draining and longer time period for energy generation.

The at least one pump 114 of the power generation system 112 is fluidly coupled to the first water storage unit 122 and the at least one second water storage unit 126. The at least one pump 114 can transport water between the first water storage unit 112 and the at least one second water storage unit 126.

The at least one electrical generator 116 can be operatively coupled to the at least one pump 114 to be driven by the at least one pump 114. Each electrical generator 116 can be coupled to one or more pumps 114. For example, each electrical generator 116 can be coupled to each pump 114, or multiple pumps 114 can drive each electrical generator 116 (e.g., by each driving a driveshaft of the electrical generator 116).

The at least one electrical generator 116 can operate as a motor and as a generator. For example, in a first mode of operation, the electrical generator 116 can be driven by the at least one pump 114 to generate electrical power (e.g., the at least one pump 114 acts as a prime mover), and in a second mode of operation, the at least one electrical generator 116 can use electrical power from a remote source to drive the at least one pump 114. In some embodiments, the at least one pump 114 is configured to operate as both a pump and a turbine (e.g., can use electrical power from the electrical generator 116 to be driven in a first mode to move water in a first direction, and can use kinetic energy from water flow through the pump in a second mode to drive the electrical generator 116 to cause the electrical generator 116 to generate electrical power). In some embodiments, the at least one pump 114 is configured as a pump unit and a separate turbine unit. In some embodiments, the PSH system 100 outputs at least some of the generated electrical power to a battery.

In various embodiments, to standardize the modular PSH system 100 for low costs and rapid deployment, and still address the site-to-site variability, each housing 110 can contain multiple pumps 114 that can be operated individually or together. In some embodiments, the pumps 114 can be configured to function as both pumps and turbines. In an example embodiment, pump 114 which can be used in the PSH system 100, each pump 114 operates at 12.6 cubic feet per second (cfs) and 120 feet of head to provide 100 kW of instantaneous power. It will be appreciated that various pumps having similar performance parameters may be used in the PSH system 100. As such, the PSH system 100 has a relatively low capital cost: for example, with a complementary pump, generator, and motor, the PSH system 100 may have a cost of approximately $70,000-$80,000. In some embodiments, the pump 114 and corresponding electrical generator 116 is small enough that up to six pairs (of pumps 114 and corresponding electrical generators 116) could be contained in the housing 110 (e.g., a housing 110 made from a 40-foot shipping container), to make a 600 kW module. As such, in a distributed system of coordinated storage at multiple locations, 166 of these 600 kW modules (e.g., 166 of the housings 110 with corresponding power generation systems 112) can provide 99.6 MW of power output, representing an approach to achieve less than 100 MW with less than 4 hours of storage capacity.

The PSH system 100 may include a manifold 118 coupled to the power generation system 112. The manifold 118 may be disposed within the housing 110 to improve the modularity of the PSH system 110. The manifold 118 can be coupled to the first water storage unit 122 to receive a first flow of water from the first water storage unit 122 and transport the first flow of water through the power generation system 112 to the second water storage unit 126. In some embodiments, the manifold 118 is a penstock manifold. The manifold 118 can selectively control flow of water into one or more pumps 114 of the power generation system 112. For example, where the power generation system 112 is being used to generate electrical power from the kinetic energy of water flowing from the first water storage unit 122 to the second water storage unit 126, the manifold 118 can selectively direct the flow through one or more pumps 114 depending on a desired power output for the PSH system 100 (or depending on the flow rate of water from the first water storage unit 122, so that the pump(s) 114 are being operated as close as possible to optimal efficiency as a function of flow rate). As such, the manifold 118 distributes the water to multiple units (e.g., pumps 114) of the power generation system 112, keeping the flow rate into each unit within a range for optimal efficiency.

In some embodiments, the PSH system 100 includes at least one of a first water level sensor 124 disposed in the first water storage unit 122 or a second water level sensor 128 disposed in the second water storage unit 126. The water level sensors 124, 128 can measure the level of water in the respective water storage units 122, 126 (e.g., measure the first elevation of the first volume of water and the second elevation of the second volume of water) and output sensor data indicating the level of water.

The PSH system 100 includes a control system 130. The control system 130 includes a control circuit 134 and communications electronics 138. The control circuit 134 (e.g., processing circuit, processing electronics) can include a processor and memory. The processor may be implemented as a specific purpose processor, an application specific integrated circuit (ASIC), one or more field programmable gate arrays (FPGAs), a group of processing components, or other suitable electronic processing components. The memory is one or more devices (e.g., RAM, ROM, flash memory, hard disk storage) for storing data and computer code for completing and facilitating the various user or client processes, layers, and modules described in the present disclosure. The memory may be or include volatile memory or non-volatile memory and may include database components, object code components, script components, or any other type of information structure for supporting the various activities and information structures of the inventive concepts disclosed herein. The memory is communicably connected to the processor and includes computer code or instruction modules for executing one or more processes described herein. The memory includes various circuits, software engines, and/or modules that cause the processor to execute the systems and methods described herein. The control circuit 134 can include a programmable logic controller (PLC) configured to control operation of the power generation system 112 and components thereof. The control circuit 134 can implement various software and controls, such as a supervisory control and data acquisition (SCADA) system with information feeds from water pumping cycles and electricity real time markets, to control operation of robust equipment (e.g., power generation system 112) able to cycle on and off many times an hour, which may result in handsome net revenues on the arbitrage market. The control circuit 134 can implement various software packages to manage water demand forecasting and provide nearly instantaneous data, e.g. WaterSmart, WEAP (Water Evaluation and Planning).

The communications electronics 138 are configured to receive and transmit data. The communications electronics 138 can include receiver electronics and transmitter electronics. The communications electronics 138 can provide for wired or wireless communications between the various components of the PSH system 100, such as between control system 130 and the power generation system 112, manifold 118, sensors 124, 128, solar power device 142, and any valves or other flow control devices (not shown) which may be electronically controlled to control flow of water through the PSH system 100. The communications electronics 138 can transmit control commands from the control circuit 134 to various other devices, and transmit status data or sensor data from various devices to the control circuit 134. The communications electronics 138 can be configured for Ethernet or other wired communication protocols, and/or WiFi, Bluetooth, and other wireless communication protocols. The communications electronics 138 can retrieve data from remote sources via an Internet connection, such as to retrieve weather data, solar data, or other information for operation of the PSH system 100.

The control circuit 134 controls operation of the power generation system 112 based on operation conditions. For example, the control circuit 134 can cause the power generation system 112 (and the components thereof) to operate in different modes of operation based on operating conditions.

In a first mode of operation, the power generation system 112 can be configured to generate electrical power (e.g., generate electricity using kinetic energy from water flow). For example, in the first mode of operation, the at least one pump 114 receives a first flow of the first volume of water from the first water storage unit 122. The at least one pump 114 transports the first flow to the at least one second water storage unit 126 and, using the kinetic energy of the first flow (e.g., by operating as a turbine), the at least one pump 114 drives the at least one electrical generator 116 to generate electrical power, which can be outputted to a remote electrical power source, such as an electrical grid connection. In some embodiments, the PSH system 100 includes an additional return line (not shown) which can be used to return water from the at least one second water storage unit 126 to the at least one first water storage unit 112, such as to alleviate water flow overlap as water is transported from the first water storage unit 122 to the at least one second water storage unit 126 when operating in the first mode of operation.

In a second mode of operation, the power generation system 112 can be configured to use electrical power received form the remote electrical power source to transport water from the at least one second storage unit 126 to the first water storage unit 122. For example, in the second mode of operation, the at least one electrical generator 116 uses electrical power from the remote electrical power source to drive the at least one pump 114. While being driven, the at least one pump 114 transports a second flow of the second volume of water received from the at least one second water storage unit 126 to the first water storage unit 122.

The operation condition may correspond to at least one of a time of day or a price of the electrical power received from the remote electrical power source. The control circuit 134 may include a database storing operation conditions and corresponding modes of operation. For example, the database may map at least one of time of day or price of electrical power to either the first mode of operation or the second mode of operation. The control circuit 134 can store a clock, retrieve a time of day from the clock, and retrieve the mode of operation from the database based on the time of day. The control circuit 134 can similarly retrieve the price of electrical power (e.g., from a remote source via an Internet connection), and retrieve the mode of operation from the database based on the price.

The control circuit 134 may additionally or alternatively execute a policy, heuristic, or other algorithm to calculate the mode of operation to execute based on the operation conditions, such as to ensure that the PSH system 100 is operating so that the electrical power generated in the first mode of operation provide greater revenue than the cost of electrical power used to operate in the second mode of operation, or so that the PSH system 100 is operating above a desired RTE. In some embodiments, the control circuit 134 can compare the price to a price threshold, cause the power generation system 112 to operate in the first mode of operation if the price is greater than the price threshold (e.g., corresponding to peak hours, so that the PSH system 100 can sell back electricity to the remote electrical power source at a relatively high price), and cause the power generation system 112 to operate in the second mode of operation if the price is less than or equal to the price threshold (e.g., corresponding to off-peak hours, so that the PSH system 100 can transport water back to the first water storage unit 122 when electricity from the remote electrical power source can be purchased at a relatively low price). The price threshold may be a pre-determined price threshold. The price threshold may be adjusted over time. For example, the control circuit 134 can be configured to record price data as a function of time, calculate the RTE for operation of the PSH system 100 over a period of time (e.g., previous day, previous week, previous month, previous year, or a previous set of time periods, such as if the RTE is being calculated for August, calculating RTE for operation during August for one or more previous years), and adjust the price threshold so that the RTE is expected to be greater than a desired RTE threshold. As such, the control circuit 134 can dynamically adjust operation of the PSH system 100 to take advantage of current operational economics. The control circuit 134 can also calculate an expected RTE based on time of year (e.g., based on expected energy usage for the time of year).

In some embodiments, the control circuit 134 determines the mode of operation based on at least one of the first elevation of the first volume of water stored in the first water storage unit 122 and the second elevation of the second volume of water stored in the second water storage unit(s) 126. For example, the first water storage unit 122 may have minimum and/or maximum water level thresholds, so that the control circuit 134 does not cause the power generation system 112 to transport water into the first water storage unit 122 unless the first elevation is less than maximum water level threshold, and the control circuit 134 does not cause the power generation system 112 to transport water out of the first water storage unit 122 unless the first elevation is greater than the minimum water level threshold. The control circuit 134 can retrieve the water elevations from the first water level sensor 124 and the second water level sensor 128.

In some embodiments, the PSH system 100 includes a solar power device 142. The solar power device 142 is configured to receive light and generate electrical power using the received light. The solar power device 142 may include one or more solar panels (e.g., solar photovoltaic panels). In some embodiments, the solar panel(s) of the solar power device 142 are oriented at a predetermined angle corresponding to a desired light capture, which may depend on/be determined based on a geographic location of the PSH system 100, a time of day, a time of year, or other factors used to determine desired or optimal solar panel orientation. In some embodiments, the angle of the solar panel(s) may be adjusted as a function of time (e.g., using a maximum power point tracking algorithm). The angle of the solar panel(s) may be adjusted by a control circuit of the solar power device 142, which may calculate the angle or may retrieve the angle from a database based on time and/or location data.

The PSH system 100 can provide adequate capacity for peak demands, domestic, and fire flow demands during peak hours. Service pressure must be maintained for various demands: typically in the range of 20 psi minimum under fire flow condition and 45 psi minimum under peak domestic flow conditions. Additionally, the PSH system 100 can maintain adequate water quality where a key action is mixing to achieve water turnover.

In some embodiments, the PSH system 100 has a power output capacity less than 5 MW. By using existing infrastructure and configuring the housing 110 for modular deployment, the PSH system 100 can have rapid deployment, and low capital costs. In embodiments where the housing 110 is made from a shipping container, the intermodal logistics for the housing 110 are efficient worldwide. Similarly, where the housing 100 is made as a standardized module, prefabricated in a controlled factory environment, on-site costs can be reduced, and opportunity can be created for keeping part inventories to speed fabrication, assembly, and equipment delivery times. These same features of the PSH system 100 can reduce development costs and timelines—much of the engineering is already done, and the modular approach can accommodate a certain degree of site-to-site variation. Further, installation costs for the PSH system 100 can be kept low by efficient scheduling such as when the water tank is being drained for required inspection, for repairs, or when a new one is being installed.

As noted above, in some embodiments, the power generation system 112 can include the pump 114 and electrical generator 116 as two separate pieces of equipment: a pump/motor and a turbine/generator. In some embodiments, the power generation system 112 can implement the pump 114 and electrical generator 116 using a combined pump and turbine device, such as, the model pump-as-turbine 10TR-1 produced by Cornell Pump Company is an example of equipment that may work well in this mode of operation for the PSH system 100. A pump-as-turbine has the advantages of low cost, availability of many parts off the shelf, durability, familiar to potential water works customers, and capability to be turned on and off many times an hour—which can facilitate maximizing net revenues in the arbitrage market for electricity pricing.

For example, for the 10TR-1, at a head of 120 feet the associated operating flow and power are 12.6 cfs (5,646 gpm) and 100 kW, respectively. Table 1 presents some possible implementations of the PSH system 100, using a single housing 110 with a power generation system 112 having with six turbines and six pumps. Using the manifold 118 with each turbine individually gated, water can flow through one or more turbines at a time. In the scenario in Table 1 there are 1,350,000 gallons of water available. The flow rate through each turbine is the same; 12.6 cfs (5,646 gpm). If all six turbines are open at once then the storage will drain in 20 minutes (0.66 hours). If only one turbine is open the storage drains in just less than four hours. This flexibility of the PSH system 100 can enable access to more than one potential value stream.

TABLE 1
Conceptual scenarios demonstrating potential
flexibility of storage times.

| No. | Discharge | | Power @ 78% | ca. Power @ |
|---|---|---|---|---|
| Turbines | time | Head | turbine efficiency | 70% RTE |
| Open | (hrs) | (ft) | (kW) | (kW) |
| 6 | 0.66 | 120 | 600 | 538 |
| 4 | 1.00 | 120 | 400 | 359 |
| 2 | 2.00 | 120 | 200 | 179 |
| 1 | 3.98 | 120 | 100 | 90 |

Referring now to FIGS. 2A and 2C, a PSH system 200a is shown according to an embodiment of the present disclosure. The PSH system 200a can incorporate features of the PSH system 100. The PSH system 200a can be configured to be retrofit to an existing water supply system having both an existing water tower storing water at a relatively high elevation, and one or more existing water reservoirs storing water at or near ground level.

As shown in FIG. 2A, the PSH system 200a includes a housing 210 in which a plurality of pumps 214 and a manifold 218 for selectively flowing water into the pumps 214 are disposed. A first water storage unit 220 (e.g., water tower), stores a first volume of water 222 at a first elevation 224. A first water line 226 (e.g., pipe, tube) connects the first water storage unit 220 to the housing 210 (e.g., to manifold 218 within housing 210), so that the pumps 214 can receive a first flow of the first volume of water 222 from the first water storage unit 220 via the first water line 226. The first water storage unit 220 may also include a remote water line 228 to connect the first water storage unit 220 to a remote water system (e.g., municipal water system). While FIG. 2A shows six pumps 214, various numbers of pumps 214 may be used depending on the size selected for the housing 210 and the expected water flow conditions for operation with the first water storage unit 220 and at least one second water storage unit 230a.

At least one second water storage unit 230a is also provided. The at least one second water storage unit 230a can be an existing water reservoir at or near ground level. The at least one second water storage unit 230a stores a second volume of water 232 at a second elevation 234 which is less than the first elevation 224. The kinetic energy that the PSH system 200a can extract from flowing water from the first water storage unit 220 to the at least one second water storage unit 230a (in order to generate electrical power) corresponds to a difference between the first elevation 224 and the second elevation 234; similarly, the electrical power needed to transport water from the at least one second storage unit 230a to the first water storage unit 220 corresponds to the difference between the first elevation 224 and the second elevation 234. It will be appreciated that the elevations 224, 234 will change as water flows between the water storage units 220, 230a.

The PSH system 200a can include a solar power device 240. The solar power device 240 can be used to generate solar electrical power to facilitate transporting the second flow of water from the second water storage unit 230a to the first water storage unit 220, which can offset the need to purchase electricity from the remote electrical power source for driving the pumps 214. The solar power device 240 can also be used to generate solar electrical power which is at least partially transmitted to the remote electrical power source (e.g., sold to the remote electrical power source), such as when water is not being transported from the second water storage unit 230a to the first water storage unit 220, increasing the revenue that the PSH system 200a generates.

Referring now to FIGS. 2B and 2D, a PSH system 200b is shown according to an embodiment of the present disclosure. The PSH system 200b can incorporate features of the PSH systems 100, 200a. The PSH system 200b is similar to the PSH system 200a, but includes at least one second water storage unit 230b which is not an existing water storage unit like the water storage unit 230a of FIG. 2A.

As shown in FIG. 2B, the PSH system 200b includes at least one second water storage unit 230b. The at least one second water storage unit 230b is made from a shipping container (e.g., a standard shipping container, an ISO shipping container), similar to the housing 210. The at least one second water storage unit 230b can include a liner in order to store water. The at least one second water storage unit 230b stores the second volume of water 232 at the second elevation 234. In some embodiments, the at least one second water storage unit 230b includes a plurality of water storage units. For example, the at least one second water storage unit 230b can include 25 water storage units 230b having a capacity of 40,000 gallons each (e.g., based on a standard shipping container size) to operate with the water storage unit 220 having a total capacity of 1,000,000 gallons. In various PSH systems in accordance with the present disclosure, the number of pumps (e.g., pumps 214) and water storage units (e.g., water storage units 230b) may be varied based on total capacity of the upper reservoir water storage unit (e.g., water storage unit 220) and desired RTE.

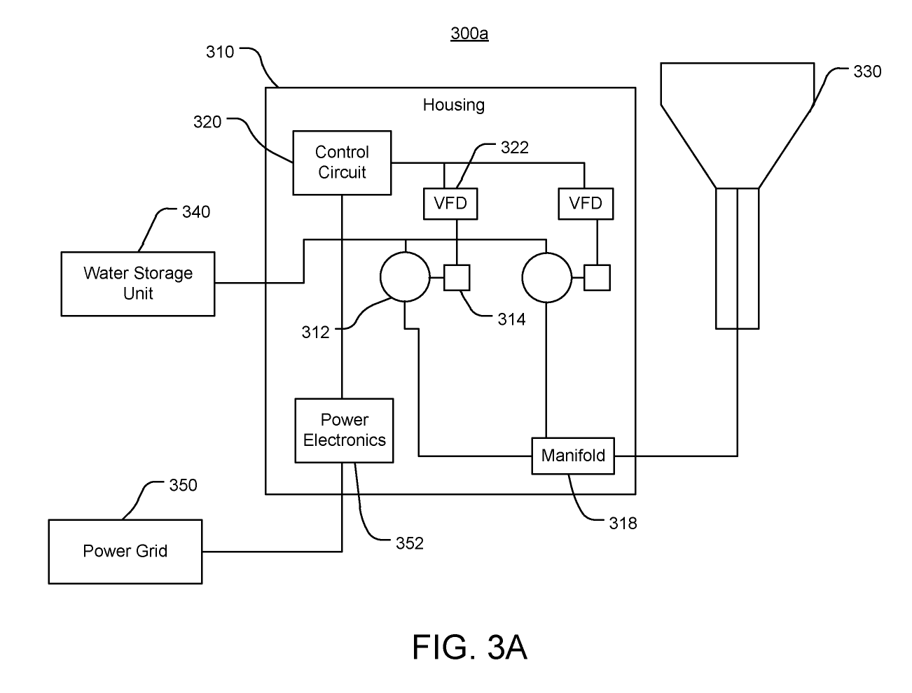

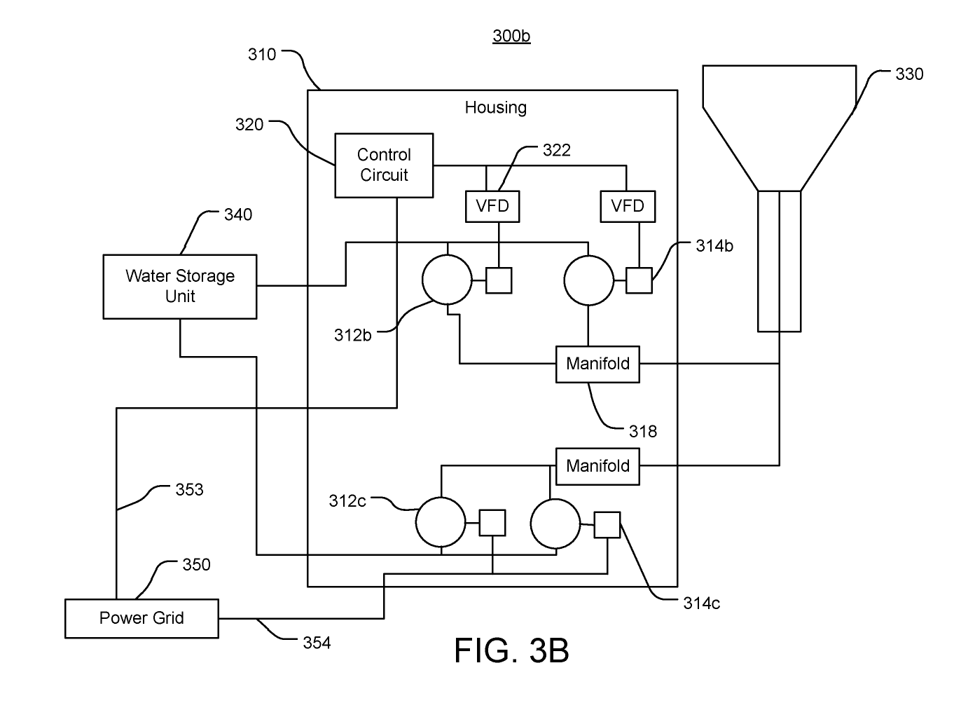

Referring now to FIG. 3A, a PSH system 300a is shown according to an embodiment of the present disclosure. The PSH system 300a can incorporate features of the PSH systems 100, 200a, 200b, and uses a combined pump and turbine (e.g., reversible pump). As shown in FIG. 3A, the PSH system 300a includes a housing 310 in which a plurality of pumps 312 and a plurality of electrical generators 314 (e.g., electrical machines configured to operate as motors and as generators) are disposed. The pump 312 can be reversible, such that it can transport water from the water storage unit 330 (e.g., upper reservoir) to the water storage unit 340 (e.g., lower reservoir) or vice versa, depending on the desired mode of operation. In the configuration of FIG. 3A, with a single pump/turbine connected to a single generator/motor, total cost may be reduced because a single component is used. The PSH system 300a also includes a manifold 318 for selectively controlling flow to the pumps 312 from water storage unit 330.

A control circuit 320 (e.g., PLC) controls operation of the pumps 312 and/or electrical generators 314, manifold 318, and other valves which may be provided for controlling flow through the PSH system 300a. In some embodiments, the PSH system 300a includes variable frequency drives 322 (VFDs) to control operation of the electrical generator 314. The VFD 322 can adjust operation speeds (e.g., rotation speeds) of the electrical generators 314 based on a control signal generated by the control circuit 320, such as to modify operation of the electrical generators 314 according to an algorithm mapping speed to efficiency or other performance parameters (e.g., using a power curve). In embodiments such as shown in FIG. 3A, the VFD 322 can control both motor (e.g., driving the pump 312) and generator (e.g., being driven by the pump 312) operations of the electrical generator 314. Other adjustable speed drives may also be used in place of the VDF 322.

The control circuit 320 can receive sensor data regarding water levels in the water storage units 330, 340 from water level sensors disposed in the respective water storage units, and control operation of the pumps 312 and/or electrical generators 314 based on the sensor data (e.g., to select a mode of operation). The control circuit 320 can execute SCADA software to monitor electrical market data (e.g., retrieve and monitor price data), and can communicate with the level sensors to determine water levels; the control circuit 320 can control operation of the PSH system 300a using various such data.

In some embodiments, the PSH system 300a includes power electronics 352, which may modulate flow of electrical power to/from power grid 350. The power electronics 352 can include a power supply for powering the components within the housing 310. The power electronics 352 may include a fused disconnect. In some embodiments, the PSH system 300a includes a utility transformer (not shown) disposed outside the housing 310 to electrically couple the PSH system 300a to the power grid 350.

It will be appreciated that there may be tradeoffs between efficiency and the use of separate units for equipment in the size and power capacity range desired for PSH systems in accordance with the present disclosure. As such, in some embodiments, such as shown in FIG. 3B, a PSH system 300b includes separate pump and turbine components, rather than a single pump/turbine. The PSH system 300b includes control circuit 320 to control operation of the components of PSH system 300b (some control lines from control circuit 320 have been omitted for clarity). The PSH system 300b includes input pumps 312b which are driven by input electrical generators 314b (which may only have a motor function, rather than both a generation function and a motor function) using electrical power received on input power line 353 from power grid 350, such as to transport water from water storage unit 340 (e.g., lower reservoir) to water storage unit 330 (e.g., upper reservoir). In some embodiments, the input electrical generators 314b are driven by the VFD 322. The PSH system 300b also includes output pumps 312c which drive output electrical generator 314c using the kinetic energy of water flowing from water storage unit 330 to water storage unit 340, such as to generate electrical power for output to the power grid 350 via output power line 354. In an example of the configuration of FIG. 3B, 480V 3-phase line power, and 4-20 mA on twisted shielded pairs may be used.

In some embodiments, the configuration described by Table 1 corresponds to a constant head implementation of the PSH systems of the present disclosure. In some embodiments, the head height changes when the water in the storage tank (e.g., first water storage unit 122 of FIG. 1) drains, and the flow rate of the water through the outlet drops. For example in a simple bottom-draining tank, assuming a discharge coefficient of 0.94, a 17% change in head (e.g. 20 ft drop in 130 ft head) causes the discharge flow to drop approximately 9%. In embodiments implementing fixed-speed equipment like the Cornell 10TR-1 mentioned above, a throttling valve can be used to adjust to changes in flow. For example, the throttling valve can be used to shift the performance of the pump-as-turbine (e.g., pump 114 of FIG. 1; pump 312a of FIG. 3A) to the left on the performance curve toward a lower efficiency regime.

In some embodiments of the PSH system 300b of FIG. 3B, the best efficiency point (BEP) of the PSH system 300b may be 80%. However, efficiency losses due to the various components of the PSH system 300b, such as the pump and electrical equipment, may reduce the RTE below a desired threshold (e.g., below 70%). The PSH systems of the present disclosure improve upon existing PSH technology to overcome such efficiency challenges, such as by implementing more advanced adjustable speed drives (ASD) to adjust the pump's rotational speed, (e.g., using VFDs such as VFD 322). In an embodiment, The VFD 322 executes pulse width modulation to control the operational speed of the electrical generator (e.g., electrical generator 314b). In some embodiments, the VFD 322 uses a multi-level voltage source inverter, which may reduce costs and/or complexity by providing a simpler two-winding transformer rather than three-winding transformer. ASD pumps can improve upon existing systems because they can operate at lower speeds, and in certain centrifugal pump situations in which power requirements vary with the cube of the speed, there can be significant savings on energy use in addition to reduced bearing loads, shaft deflection, and maintenance.

In some embodiments, PSH systems in accordance with the present disclosure can improve upon existing systems by using a mix of turbines with different BEPs that compensate for each other when working together. This mix could be combined with ASD. In various such embodiments, higher efficiencies be achieved at heads and flows distinct from the BEP. For example, with respect to the PSH system 300a, the PSH system 300a may include a plurality of pumps 312 having different BEPs, and the control circuit 320 can control operation of speed of the VFDs 322 based on a known or expected flow rate, a desired RTE, and each of the different BEPs.

In various embodiments, optimizing the configuration of the turbine or pump runner may get a few percentage points improvement in efficiency. In some embodiments, the PSH systems disclosed herein may use polishing or an inside coating to reduce friction. For example, Jain et. al. found blade rounding led to 3-4% rise in efficiency for a pump running in turbine mode. Wu et al. report 3.3% gain with optimization. The Francis type turbines in Wu's paper exhibited peek efficiencies in the 90's, even before optimization. With the relatively low volumes of water associated with water towers the frictional losses will be more significant and efficiencies in the 90's are not expected.

Using the technical improvements described herein, PSH systems of the present disclosure can achieve an RTE of at least 70 percent. An example RTE determination is described below. As noted above, the RTE is a measure of the ratio of the power produced by the turbine/generator to the power consumed by the pump/motor. In some systems (e.g., centrifugal pump systems), efficiencies range from 85 percent to 87 percent in head and flow rates of interest for the PSH systems. Synchronous motors can have efficiencies of over 99 percent. In embodiments where a VFD is used, another loss may be introduced; for example, the VFDs can be 98 percent efficient. A turbine/pump in generating mode is generally more efficient than in pump mode, but in the interest of conservatism it may be assumed to be the same. Then the estimated roundtrip efficiency is slightly above 70 percent:

RTE=(0.86×0.995×0.98)²=0.703

As such, the technical improvements described herein can make RTE greater than 70% is achievable.

As noted above, PSH systems in accordance with the present disclosure can use solar power devices to offset the energy required to transport water from a lower elevation to a higher elevation and/or sell electricity back to the grid. Adding solar panels to the PSH systems (e.g., mounting on housing 110 or other housings described herein) can increase round trip efficiency and potential value streams. Control circuit 134 can control operation of solar power device 142 based on logic control and distribution board offset peak time power supply shortfalls.

In some embodiments, such as during the second mode of operation, a water return pump (e.g., operating pumps 312b of FIG. 3B or pumps 312 of FIG. 3A) is utilized during the off peak hours to return municipal water level to the original state. Solar panels on the roof mitigate return pumping costs during the daylight hours, which can maximize arbitrage revenues. In some embodiments, an additional return line is used to alleviate overtopping with supply during peak hour power delivery. Solar panels feed directly into the electrical grid when not in use. An example cost calculation for operation of the PSH systems of the present disclosure is described below. Assuming that the elevation of the solar panels is optimized for the site latitude and that the panel azimuth is 180 degrees, taking a rough weighted average of solar capacity factors for the continental USA, it can be estimated that each unit carries sufficient panels to produce approximately 55 MWh of power per year. Assuming a retail electricity price of $0.10/kWh, this is $5,500 worth of power per year. To determine whether this begins to offset pumping costs, the cost of pumping water can be calculated as

C=0.746Qhc/(3960μₚμₘ)
where

C=cost per hour ($)

Q=volume flow (gpm)

h=head (ft)

c=cost rate per kWh (USD/kWh)

μₚ=pump efficiency

μₘ=motor efficiency

Assuming the PSH system is pumping water back up to a height of 120 feet, and that efficiency of each of the pump and motor are 85 percent each, this yields a very approximate running cost, per pump, of $2.10 per hour, or $12.60 for each six-pump module. In other words, each module should make enough solar power to run its pumps for about 1.25 hours per day. As such, the use of the solar power device (e.g., solar power device 142) can provide a significant increase in overall system efficiency, even with an increased initial capital cost. Accordingly, PSH systems in accordance with the present disclosure can advance new closed-loop PSH technology, being likely to have a round trip efficiency that exceeds 70%. Similarly, the PSH system's power class, closed-loop nature and association with conduits, use of existing infrastructure, and modularity support short deployment timeframes, and low capital costs.

The PSH systems of the present disclosure can also provide improved cost efficiencies over battery-based energy storage technologies (e.g., in the <1 MW power and 4 hours or less storage class). The arbitrage market alone may be able to provide a net of 2-4 ¢/kWh, buying low and selling high, on the real time market, especially where the PSH system is configured to maximize differentials on the 5-15 minute time scale (e.g., through the use of control electronics and pump/generator components which can change between the first and second modes of operation on these time scales).

With respect to providing technical and cost advantages over battery based technologies in particular, according to data from DOE/EPRI Electricity Storage Handbook, Sandia Report SAND2015-1002, installed costs for batteries, sodium metal halide 27 kW/3 hrs is ˜$8500/kW. For 200 kW/3.5 hr Vanadium Redox battery storage installed cost is $4,000/kW. In contrast, initial capital costs (ICC) for a 600 kW PSH system in accordance with the present disclosure is less than $1800/kW. To add a lower reservoir made out of shipping container tanks (e.g., as described with respect to FIG. 2B) that can store 2 million gallons of water might double the ICC. Adding solar panels increases the cost, but also the capacity.

In some embodiments, the PSH system (e.g., PSH system 100) can improve existing water supply systems by mixing the water as it is transported between the first water storage unit 122 and second water storage unit 124. Regarding integration with a water system, the AWWA report on Finished Water Storage Facilities identifies serious problems arising from contaminated water in storage systems. In some embodiments, the PSH system 100 includes at least one of watertight seals, water monitoring, or leak alarms to reduce the risk of contaminated water. In the report, excessive water age was described as probably the most important factor related to water quality deterioration. Contaminates that enter through numerous access points, e.g. hatches, appurtenances, sidewall joints, vents and overflow piping, can subsequently grow in the stagnate water. By mixing the stored water, the PSH system 100 can prevent formation of “old” water. In some embodiments, the PSH system 100 includes filters or sediment traps to prevent stirring up of sediment. For example, sediment accumulation can occur in quiescent conditions, and in some of these cases mixing may have the undesirable effect of stirring up sediment to the point water quality particulate concentration limits are exceeded.

In some embodiments, the PSH system includes at least one of water level sensors, pressure sensors, or flow sensors configured to output water flow data regarding flow of water in the PSH system (e.g., in first water storage unit 122) as well as between the PSH system and a remote water system (e.g., municipal water system). As such, the PSH system can maintain required available water and pressure by controlling operation of the PSH system based on the water flow data.

In some embodiments, the PSH system includes relatively short pipe lengths (e.g., from first water storage unit 122 to housing 110) and/or controls valve closing operations based on pressure data. As such, pressure transients and other similar concerns for integrating the PSH system into existing water supply infrastructure can be alleviated.

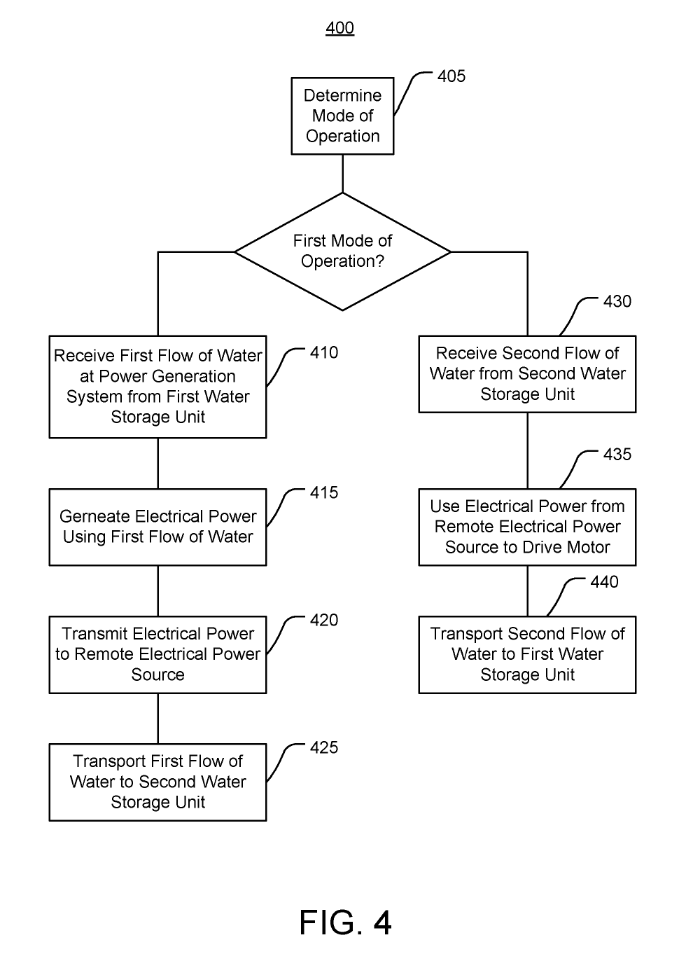

Referring now to FIG. 4, a method of operating a PSH system is shown according to an embodiment of the present disclosure. The method can be performed using the various PSH systems described herein (e.g., PSH systems 100, 200a, 200b, 300a, 300b).

At 405, a mode of operation is determined based on an operating condition. The operating condition may include at least one of a time or a price of electrical power. The operating condition may include an expected efficiency of operation (e.g., a round trip efficiency).

If the mode of operation is a first mode of operation, then at 410, a power generation system receives a first flow of water. The power generation system is disposed in a housing, which may be made from a shipping container. The first flow of water is received from a first water storage unit, such as a water tower, which stores a first volume of water at a first elevation.

At 415, the power generation system generates electrical power using the first flow of water. The power generation system may include a pump which is driven by kinetic energy of the first flow of water to drive an electrical generator.

At 420, the power generation system transmits the generated electrical power to a remote electrical power source. The remote electrical power source may be an electrical grid. The remote electrical power source may be a battery.

At 425, the power generation system transports the first flow of water to a second water storage unit. The second water storage unit stores a second volume of water at a second elevation that is lower than the first elevation. The second elevation may be at or near (e.g., above or below) ground level.

If the mode of operation is a second mode of operation, then at 430, the power generation system receives a second flow of water from the second water storage unit.

At 435, the power generation system uses electrical power from the remote electrical power source to drive a motor. The motor may be the electrical generator used to generate electrical power in the first mode of operation, or may be a separate motor. The motor drives a pump (which may be the pump driven by kinetic energy of the first flow of water in the first mode of operation, or may be a separate pump). At 440, the power generation system transports the second flow of water to the first water storage unit.

The present solution advances PSH technology by providing a modular system with low capital costs which can be easily integrated into existing water systems, can take advantage of cyclical differences in electricity prices, and can improve existing water systems by mixing the stored water. The present solution can also advance PSH technology such as adjustable speed and integrated reversible pump/turbines, into a power class with the most advantageous regulatory timeframes. This combination of leveraging existing infrastructure, favorable regulations, advanced technology, and modularity with shipping container logistics leads to PSH with low capital costs and short deployment timeframes.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to some embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A pumped storage hydropower system, comprising:
a first water storage unit storing a first volume of water at a first elevation;
a second water storage unit storing a second volume of water at a second elevation less than the first elevation;
a housing;
a power generation system including at least one pump disposed within the housing and an electrical generator, the at least one pump fluidly coupled to the first water storage unit and the second water storage unit to transport water between the first water storage unit and the second water storage unit, the electrical generator operatively coupled to the at least one pump, the electrical generator configured to receive electrical power from and transmit electrical power to a remote electrical power source; and
a control circuit configured to control operation of the power generation system in a first mode of operation or a second mode of operation based on an operation condition, wherein the operation condition includes at least one of a time or a price of the electrical power received from the remote electrical power source,
wherein in the first mode of operation, the control circuit causes the at least one pump to receive a first flow of the first volume of water from the first water storage unit, transport the first flow to the second water storage unit, and drive the electrical generator to generate electrical power for transmission to the remote electrical power source using the first flow, and in the second mode of operation, the control circuit causes the electrical generator to drive the at least one pump, using electrical power received from the remote electrical power source, to receive a second flow of the second volume of water from the second water storage unit and transport the second flow to the first water storage unit.

2. The pumped storage hydropower system of claim 1, further comprising at least one solar power device mounted to the pumped storage hydropower apparatus, the solar power device configured to generate solar electrical power, wherein the power generation system is configured to use the solar electrical power to drive the pump to transport the second flow of the second volume of water from the second water storage unit to the first water storage unit while operating in the second mode of operation.

3. The pumped storage hydropower system of claim 1, wherein the power generation system is configured to output electrical power to the remote electrical source at a power no greater than five megawatts.

4. The pumped storage hydropower system of claim 1, further comprising a manifold configured to selectively transport water between the first water storage unit and the at least one pump, wherein the at least one pump includes a plurality of pumps.

5. The pumped storage hydropower system of claim 1, wherein the housing is a shipping container.

6. The pumped storage hydropower system of claim 1, wherein the at least one pump includes a plurality of pumps having different best efficiency points.

7. The pumped storage hydropower system of claim 1, wherein the at least one pump is configured for reversible operation.

8. The pumped storage hydropower system of claim 1, wherein the at least one pump includes a turbine unit configured to receive the first flow of the first volume of water from the first water storage unit, transport the first flow to the second water storage unit, and drive the electrical generator to generate electrical power for transmission to the remote electrical power source using the first flow when the power generation system operates in the first mode of operation, and a pump unit separate from the turbine unit, the pump unit configured to be driven by the electrical generator when the power generation system operates in the first mode of operation.

9. A pumped storage hydropower apparatus, comprising:
a housing; and
at least one pump disposed within the housing, the at least one pump fluidly coupled to a first water storage unit storing a first volume of water at a first elevation and a second water storage unit storing a second volume of water at a second elevation less than the first elevation, the at least one pump configured to operate in a first mode of operation or a second mode of operation based on an operation condition including at least one of a time of day or a price of electrical power received from a remote electrical power source,
wherein in the first mode of operation, the at least one pump receives a first flow of the first volume of water from the first water storage unit, transports the first flow to the second water storage unit, and generates electrical power for transmission to the remote electrical power source using the first flow, and in the second mode of operation, the at least one pump receives a second flow of the second volume of water from the second water storage unit, and transport the second flow to the first water storage unit using electrical power received from the remote electrical power source.

10. The pumped storage hydropower apparatus of claim 9, further comprising at least one solar power device mounted to the pumped storage hydropower apparatus, the solar power device configured to generate solar electrical power, wherein the power generation system is configured to use the solar electrical power to drive the pump to transport the second flow of the second volume of water from the second water storage unit to the first water storage unit while operating in the second mode of operation.

11. The pumped storage hydropower apparatus of claim 9, wherein the power generation system is configured to output electrical power to the remote electrical source at a power no greater than five megawatts.

12. The pumped storage hydropower apparatus of claim 9, further comprising a manifold configured to selectively transport water between the first water storage unit and the at least one pump, wherein the at least one pump includes a plurality of pumps.

13. The pumped hydropower storage apparatus of claim 9, wherein the housing is a shipping container.

14. The pumped hydropower storage apparatus of claim 9, wherein the at least one pump includes a plurality of pumps having different best efficiency points.

15. The pumped hydropower storage apparatus of claim 9, wherein the at least one pump is configured for reversible operation.

16. The pumped hydropower storage apparatus of claim 9, wherein the at least one pump includes a turbine unit configured to receive the first flow of the first volume of water from the first water storage unit, transport the first flow to the second water storage unit, and drive the electrical generator to generate electrical power for transmission to the remote electrical power source using the first flow when the power generation system operates in the first mode of operation, and a pump unit separate from the turbine unit, the pump unit configured to be driven by the electrical generator when the power generation system operates in the first mode of operation.

17. A pumped storage hydropower system, comprising:
a plurality of second water storage units storing corresponding second volumes of water at a plurality of second elevations less than a first elevation at which a first water storage unit stores a first volume of water; and
a housing and at least one pump disposed within the housing, the at least one pump fluidly coupled to the first water storage unit and the plurality of second water storage unit to transport water between the first water storage unit and the plurality of second water storage unit, the at least one pump configured to operate in a first mode of operation or a second mode of operation based on an operation condition including at least one of a time or a price of electrical power received from a remote electrical power source,
wherein in the first mode of operation, the at least one pump receives a first flow of the first volume of water from the first water storage unit, transports the first flow to at least one of the plurality of second water storage unit, and generates electrical power for transmission to the remote electrical power source using the first flow, and in the second mode of operation, the at least one pump receives a second flow of at least one of the second volumes of water from at least one of the plurality of second water storage unit, and transports the second flow to the first water storage unit using electrical power received from the remote electrical power source.

18. The pumped storage hydropower system of claim 17, further comprising a plurality of solar panels mounted to each of the plurality of second water storage unit, each solar panel configured to generate solar electrical power, wherein the pump is configured to use the solar electrical power to transport the second flow of the second volume of water from the second water storage unit to the first water storage unit while operating in the second mode of operation.

19. The pumped storage hydropower system of claim 17, wherein the pumped storage hydropower system has a round trip efficiency of at least seventy percent.

20. The pumped storage hydropower system of claim 17, wherein the plurality of second water storage units include housings formed from shipping containers.
